(19) United States
(12) Patent Application Publication
(10) Pub. No.: US 2007/0101169 A1
(43) Pub. Date: May 3, 2007

(54) IC with dual communication interfaces

(75) Inventors: Barry Male, West Granby, CT (US); Robert A. Neidorff, Bedford, NH (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/266,067

(22) Filed: Nov. 3, 2005

(51) Int. Cl. G06F 1/26

(52) U.S. Cl. 713/300

(57) ABSTRACT

A controller associated with a network connection includes a high speed local interface and a high overhead system interface. The controller can be a power controller for a power over Ethernet application. A controller for each connection is interconnected through the high speed interface. One of the controllers is configured at an address in the high overhead system interface to permit control instructions to be directed to the interconnected controllers from the host system. The architecture avoids the high overhead and complexity associated with multiple devices on the high overhead system interface and distributes processing and thermal loads among the controllers. The controller connected to the high overhead system interface can address the other controllers simply and rapidly to obtain a distributed control system for controlling power over network connections. The architecture reduces pin count, distributes thermal loads, reduces area requirements, and provides a flexible control solution.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

1. Field of the Invention

The present invention relates generally to interfaces for electronic devices, and relates particularly to an electric component or IC that supports more than one communication interface.

2. Description of Related Art

Electrical components, and ICs in particular are typically connected to each other through some type of interface, such as a shared bus. Examples of such buses are I²C and SMBus. Each IC connected to the interface or bus typically has a unique address to identify it on the bus. Device communication is usually preceded by providing an address on the bus or interface that identifies the desired device that is the target of the communication event.

In the case of a master controller, such as a processor or host computer, devices on the bus are typically accessed by the host or processor by first addressing the device and then receiving or transmitting device information. This type of interface configuration permits a large number of devices to communicate over a single bus. However, there is a large amount of overhead associated with operations on the bus, for both the devices and the host or processor.

Referring to FIG. 1, an SPI serial interface is illustrated generally as architecture 10. Architecture 10 includes a master device 12 and three slave devices 13-15. Each slave device has a separate dedicated selection signal SS provided from master device 12. The more slave devices added to the interface, the more select signals SS are needed to select the given slave device. Architecture 10 does not require a predefined protocol to permit communication between the master and slave devices, which is an advantage for data stream applications. Data can be transferred at high speed between the devices, often in the range of tens of MHz. However, the interface does not provide for acknowledgement of flow control, or even identification of a slave's presence. The increased number of selection signals SS greatly increase more layout complexity with a large number of slaves, which can lead to greater costs and space considerations in an SPI implementation.

Referring to FIG. 2, an I²C interface configuration is illustrated generally as architecture 20. This serial interface includes a master 22 and several slave devices 23-25. The I²C interface is implemented with two signals that connect all the devices, a serial data line and serial clock line. The advantage of an I²C interface is a large number of slave devices may be attached to the bus interface, and not increase the number of signals needed to connect the devices. However, there is additional processing overhead needed to identify or select a particular slave device. Master device 22 implements an addressing mechanism that permits communication with individual slave devices 23-25, for example. Each slave device 23-25 has a unique address to identify it on the bus. Accordingly, slave devices 23-25 have predefined addresses and dedicated pins to the bus in architecture 20. Due to the configuration of architecture 20, different types of speeds may be realized, with associated costs due to the level of quality required. For example, architecture 20 can support speeds of 120 kbps, 400 kbps, and 3.4 Mbps, with increasing costs associated with the increasing speed. As more devices are added to the bus interface, the bus becomes busier with communications, indicating that some applications may be required to have an increased data speed to meet the specifications of the application.

One particular application that often uses an I²C interface is in the field of network communication, such as in an Ethernet network. Each port in a network switch, for example, is typically coupled to an I²C interface that handles communication between a port and a host processor. In this type of configuration, the number of ports that can be serviced with an I²C interface may be limited due to the overhead associated with addressing each port and transferring information between a host and a port. In addition, if greater functionality is desired for each port, such as supplying power over a network connection, the overhead for each port can increase and slow down overall communication and control transmissions. The speed of the interface can sometimes be increased, but there are additional costs associated with increased speed.

### SUMMARY

The present invention involves the use of multiple interfaces for electronic device. The terms bus and interface are used interchangeably to refer to substantially the same concepts.

In accordance with the present invention, there is provided an interface configuration that permits a number of devices to communicate over a standard interface or bus through a small number of connections to the bus. The devices may be connected together with a simple, high speed interface to permit each device to communicate through another device that is coupled to the standard or main interface or bus. The small number of devices actually coupled to the main interface, such as a single device, handles the addressing and communication overhead associated with the main interface. The remaining devices are connected to the single interface device with a high speed interface, so that the device interconnection is transparent to the host. The host may access each individual device through the single interface device, which can address the devices coupled to the high speed interface and transfer information between the main interface and the addressed device.

According to an exemplary embodiment of the present invention, each device is provided with two different interfaces or buses, so that each device can be interchangeable with the main interface device. The devices are connected to each other through a simple high speed interface that can be a custom or standard interface. In addition, each device has the capability of communicating with a main interface, but may not necessarily be connected to the main interface. An example of a simple communication interface between devices is a ring bus. The devices on the ring bus have very low overhead for communicating with each other, and addressing may take advantage of position in the ring. The device connected to the main interface handles the high overhead for communicating with the main interface and can address the devices coupled to the high speed interface. The communication through dual buses or interfaces permits a system constructed with the devices to be expandable, while consistently appearing to the host as a single device connected to the high overhead bus or interface.

According to an advantage of the present invention, the simplistic local communication reduces a burden on the host and high overhead bus or interface. A reduction in the burden of the high overhead bus permits a reduction in the cost of the bus.

According to another advantage of the present invention, pin count to the devices connected on the simplistic bus can be reduced since there is no requirement for direct addressing at the high overhead interface level. In addition, devices can be programmed internally for a particular address, rather than having pins for addressing in a pin programmed addressing scheme. This ability permits a further reduction in pin count. Moreover, the simplistic interface connecting the devices can be a dedicated interface or bus that can support a large number of devices without any degradation in overall performance. The device that communicates with both the simplistic bus and the high overhead bus can also have a programmed address to communicate through the high overhead bus. Accordingly, the device can act as a single address on the main interface, and does not require any additional bus address pins for access to the main interface.

According to another advantage of the present invention, the devices connected with the simplistic interface can be controllers for ports in a network system, such as an Ethernet network. In an exemplary embodiment, a network switch may consist of a number of ports, each of which has an associated control device connected to the simplistic bus. One of the devices is also connected to a main system bus for system communication and processing. The number of devices and ports are represented to the system through the main bus as a single device with a number of ports. The controller that communicates to the system through the high overhead bus addresses the simplistic bus connected devices as a single, multi-port device. The organization of the network switch according to this configuration reduces burden on the host system and permits a reduction in the bus cost.

According to another advantage of the present invention, the device configuration in a simplistic custom interface that appears as a single device to a host system permits a great deal of flexibility in Ethernet networks that supplied power over network connections. The devices that previously were connected to the high overhead main bus directly and contributed to controlling power supplied to network connections in a power over Ethernet (POE) system represented a challenge with respect to a thermal budget in the power control system. When the devices are configured to be connected to each other with a simplistic interface to reduce interaction with the high overhead bus, the smaller pin count and more simple design for the devices permits them to be distributed in closer proximity to the ports that are sourcing power. Accordingly, the thermal load is spread over a wider area and provides greater flexibility for managing a thermal budget. In addition, the physical distribution of the devices and their association with a given port connector can minimize printed circuit board (PCB) interconnections to further simplify a (POE) system configuration. The distribution of the devices throughout one or more port modules, for example, provides a larger overall PCB area for thermal dissipation as well.

In accordance with another exemplary embodiment of the present invention, there is provided a custom high speed interface architecture, such as a ring bus, to connect devices associated with control of Ethernet ports for providing POE. The devices are register addressed using registers that can also accommodate addressing with a high overhead bus interface. Addressing devices on the custom interface can be sequential based on position in the custom interface architecture. For example, devices may be addressed based on their position in the ring bus interface.

According to an aspect of the present invention, an Ethernet POE control device is provided to each port of a multiple port network switch with each device being interconnected through a local communication architecture. The local communication architecture is connected to a system interface with a high overhead to permit system communication. The system addresses the local architecture at a single point and local addressing is provided based on positioning and the local communication architecture.

According to another embodiment of the present invention, a plurality of control devices are connected to each other through an interface that also includes a system controller. The system controller is coupled to the high speed interface, so that the devices have connections for a single interface.

### BRIEF DESCRIPTION OF THE SEVERAL VIEWS OF THE DRAWINGS

The present invention is described in greater detail below in conjunction with the accompanying drawings in which:

FIG. 1 is a block diagram illustrating an SPI serial bus interface;

FIG. 2 is a block diagram illustrating an I2c serial bus interface;

FIG. 3 is a block diagram of a device architecture in accordance with the present invention; and

FIG. 4 is a detailed block diagram of a local simple device architecture with one device coupled to a high overhead bus interface.

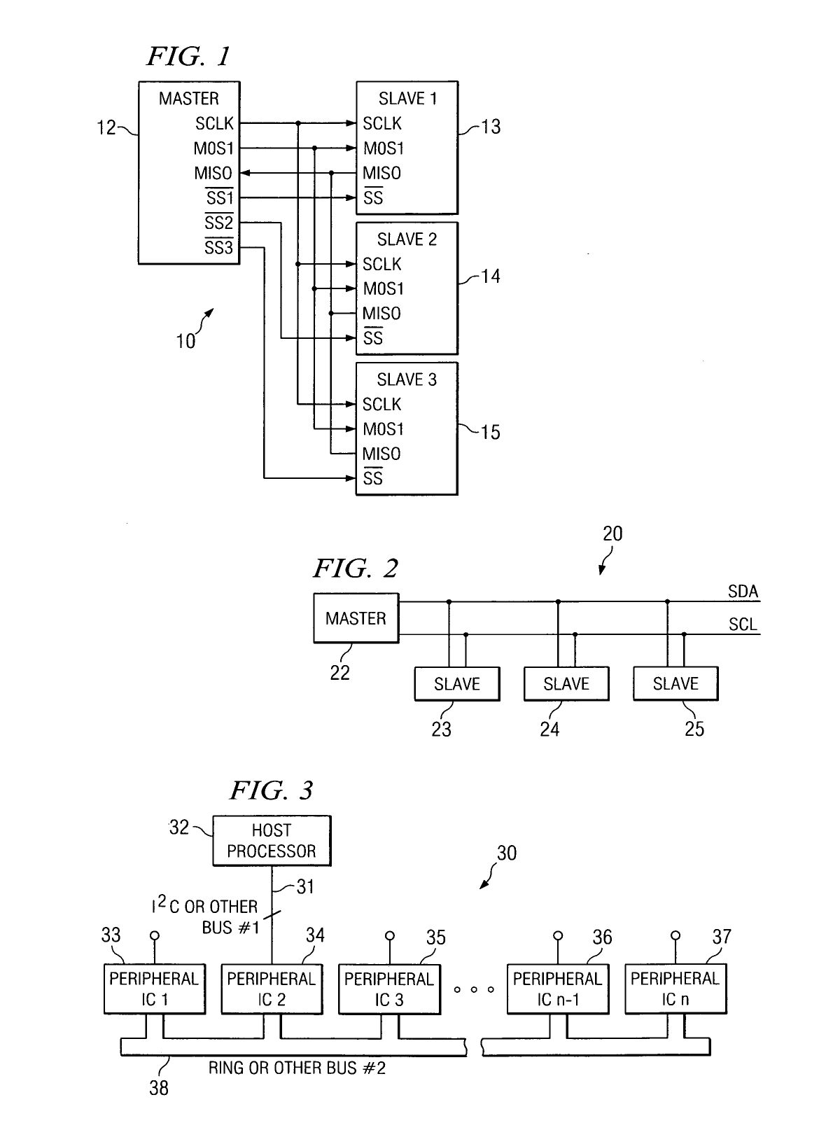

### DETAILED DESCRIPTION OF THE PREFERRED EMBODIMENTS

Referring now to FIG. 3, an architecture 30 in accordance with an exemplary embodiment of the present invention is illustrated. Architecture 30 shows a host processor 32 and multiple peripheral ICs 33-37. IC 34 is directly connected to host processor 32 over a high overhead main bus 31. ICs 33-37 are connected together with a ring type bus 38 that includes a ring input line and ring output line for each IC 33-37. Addressing on ring bus 38 is provided based on relative location in the bus path. Accordingly, bus 38 can be a custom, local high speed bus for communication among ICs 33-37. IC 34 includes the appropriate functionality for communication with host processor over high overhead main bus 31. When host processor 32 communicates with any of ICs 33-37, IC 34 is addressed with information related to any of ICs 33-37 located on ring bus 38.

IC 34 can be constructed to be the same as ICs 33 and 35-37. For example, ICs 33-37 all have a connection available for use with main bus 31. Alternately, ICs 33 and 35-37 can be constructed to be different from IC 34, so that ICs 33 and 35-37 have no connection available for main bus 31. The advantage of constructing ICs 33-37 to all be the same is reduced production costs, even if some pins on ICs 33 and 35-37 are unused. If IC 34 is constructed differently from ICs 33 and 35-37, ICs 33 and 35-37 can have a lower pin count to reduce production costs for those ICs. However, there is the potential drawback that two separate ICs are maintained to realize the invention. Alternately, IC 34 may be integrated into host processor 32 so that host processor 32 is part of ring bus 38. Such a configuration adds complexity to host processor 32 to establish the addressing of ICs 33 and 35-37, which may provide a limited increase in efficiency for communicating with ICs 33 and 35-37. However, such a configuration would eliminate high overhead main bus 31, and provide an attendant reduction in cost. In addition, host processor 32 would accommodate a custom local bus, rather than a standard interface for communicating with ICs 33 and 35-37. Such a custom solution may have additional associated costs.

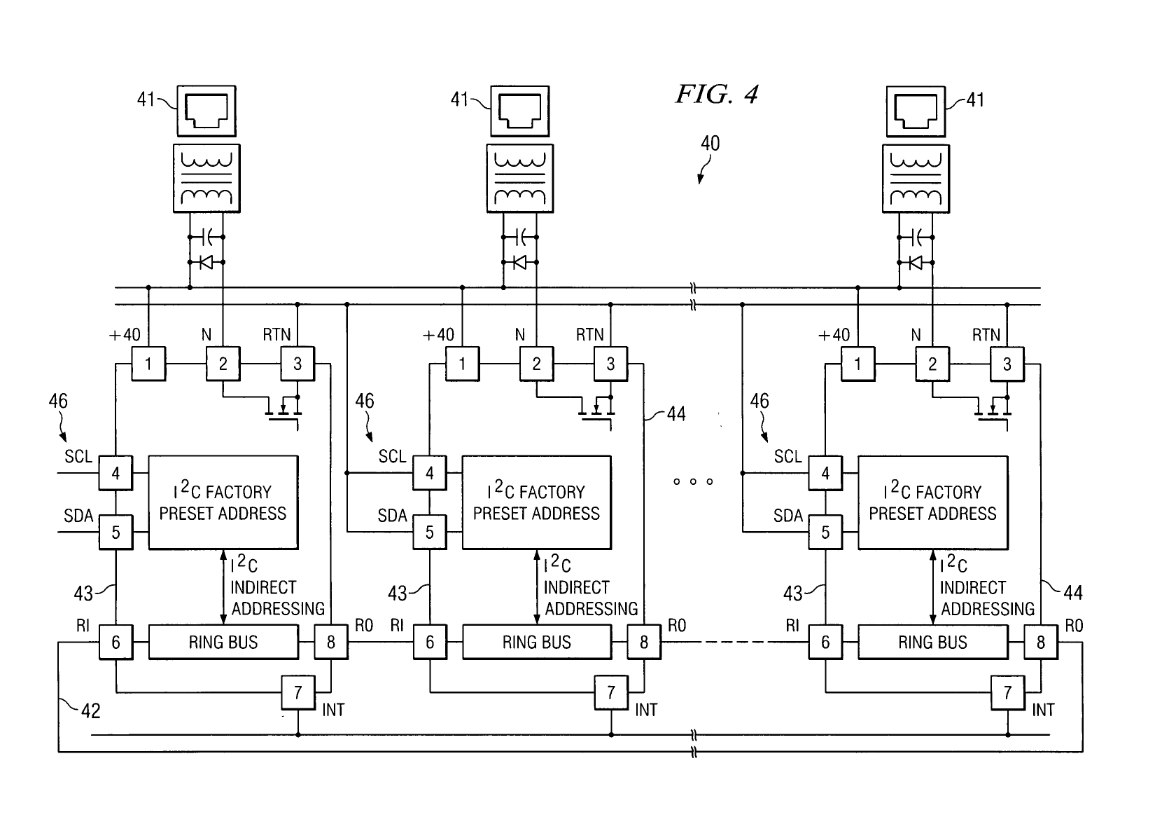

Referring now to FIG. 4, a realization of an exemplary embodiment according to the present invention is illustrated as architecture 40. Architecture 40 provides a systematic arrangement of components used in the control of Ethernet ports 41, and in particular describes a control configuration for providing POE to ports 41. Devices 43, 44 are illustrated as power controllers for POE provided to ports 41 and are constructed to each have the same configuration. Accordingly, each device 43, 44 has a high overhead main bus interface 46, shown in this exemplary embodiment as an I²C interface. A master device 43 includes an interface 46 that is connected to the I²C bus interface, while the remainder of devices 44 have no active connection to interface 46. For example, slave devices 44 have interfaces 46 connected to a common or ground reference. Accordingly, device 43 is the single point of access for devices 44 in architecture 40 through high overhead bus interface 46.

Devices 43, 44 are each connected with a second interface 42 that can be a standard or custom interface. Interface 42 is illustrated in the exemplary embodiment of architecture 40 as a ring bus interface 42. Interface 42 is a high speed, local interface for interconnecting devices 43, 44, where devices 43, 44 are addressed based on their position within ring bus interface 42. The simple structure of interface 42 permits high speed communication between devices 43, 44 with very little overhead. Accordingly, data can be rapidly exchanged between devices 43, 44 without using high overhead bus interface 46. High level commands or queries made by a system host, for example, can access architecture 40 through interface 46 of device 43, 44 so that interface 46 need only have one connection for all of architecture 40. Since device 43 alone provides the connection to the high overhead bus interface, the load on the high overhead bus is significantly reduced, which permits the high overhead bus to be de-rated for speed, for example. A reduction in the speed requirements for the high overhead bus also leads to a reduction in cost for the high overhead bus, and a reduction in system cost overall.

According to architecture 40, communication between a system host and architecture occurs through device 43 using interface 46. Device 43 can be simply addressed through interface 46, and provides access to devices 44 through local interface 42. The system host may address device 43 as a multiple device entity to permit communication between devices 44 and the system host, for example.

In an exemplary embodiment, architecture 40 is configured in a network switch as a PSE to provide POE through each of ports 41. Architecture 40 can have a number of ports 41 to provide a multiple port network switch that is capable of providing POE. High speed interface 42 can transfer power related information among devices 43, 44 to realize a POE system. Typically POE equipment or devices 43, 44 use small amount of information for the control of power supplied to ports 41. Accordingly, high speed interface 42 is particularly suited for the application of POE in architecture 40.

In prior POE realizations, control of power supplied to a port was provided through a single controller connected to a high overhead bus. The single controller provided power control for each port based on data exchange between a system host and the power controller over the high overhead interface. With architecture 40, and in accordance with the present invention, power is distributed among ports 41 so that power control can be simplified and standardized among ports 41. Accordingly, devices 43, 44 can provide power control for each port 41 and can be located in close proximity to each port 41. With this distributed configuration provided by architecture 40, the thermal output or budget of the power controller is distributed among devices 43, 44, to permit an increase in thermal budget while providing for greater thermal distribution due to the physical separation of devices 43, 44.

Devices 43, 44 can also be standardized and provided as part of a port package in either PSE or PD equipment to handle control of power, whether the power is sourced or sinked by the equipment. By distributing the power control functionality among devices 43, 44, pin count for overall power control is reduced, as well as complexity in relation to connection with the high overhead main bus interface. The reduced complexity for interfacing with a host system can reduce the cost of the high overhead bus interface. In addition, devices 44 may be realized as small scale ICs that can be located in close proximity to ports 41, or in a housing for port 41.

According to a particular embodiment of the present invention, device 43 is provided as part of a higher level controller that interfaces with a remainder of the devices 44 through a local high speed custom bus interface. That is, the functionality of device 43 that provides the connection to the host system can be integrated into a controller for the host system, permitting devices 44 to have a further reduced pin count, since there is no need for connections related to a high overhead bus.

It should be apparent that while several common interfaces and bus structures have been shown, any particular bus or interface configuration may be used. For example, the high overhead bus may be any type of pin addressable interface, or a register addressable interface on a serial bus. The high speed local interface may be configured as any type of simple communication interface, and may consist of a single line or pin connection to devices 43, 44. Moreover, while the connection to the high overhead bus interface is described using a single representative device to connect to a high speed local interface for multiple devices, the connection to the high overhead bus may be made by several devices that are interconnected in the local high speed interface. By providing several device connections to the high overhead bus, a balance can be obtained between performance on the high overhead bus and speed or complexity of the high speed local interface.

The architectural concept illustrated by architecture 40, also permits flexibility and expansion for the number of devices in the local high speed interfaces. In the exemplary embodiment of a ring bus interface, additional devices can be added simply through an insertion in ring bus interface 42. Accordingly, architecture 40 can be constructed in modules consisting of multiple ports that can be ganged together, and still provide a single connection to a high overhead bus interface, for example.

The single device connected to the high overhead bus interface representative of all the locally connected devices can be set to have a single address accessible over the high overhead bus interface to further reduce pin count for the device. For example, where a high pin count or number of traces is used to realize a high overhead bus interface, the present invention permits a reduction in the number of pins or trace lines by setting the single device to be the only device, or one of few devices on the high overhead bus interface. The solution according to the present invention is thus able to take advantage of the features of the high overhead bus interface, while providing high performance at a reduced cost and complexity.

An advantage of the device architecture in accordance with the present invention is distributed intelligence for power control in an Ethernet network. For example, each of the devices controlling power to a port connected to the local high speed interface can act as intelligence switches, due to their simplicity and high level of functionality. The various devices can communicate with each other to provide responses to power supply events, such as transients or the loss of a main power supply, without needing to communicate with a host system through the high overhead interface.

Furthermore, additional intelligence can be incorporated into each device on the local high speed interface to determine various priorities, for example. Such priorities may include communication priorities, shut down priorities, and the like.

The concepts described in the present invention are applicable to a wide variety of power distribution systems. A particular example is a system where components or modules may be hot swapped to avoid the need to shut down overall system power. Examples of these types of systems include communication networks, storage networks, and security networks. For example, a RAID array of storage devices can benefit from the present invention because power can be selectively controlled for each RAID device and the Raid device may be removed or inserted without shutting of system power. Another general application is for USB port connections, where devices may be plugged in or out at random.

In general, the present invention is applicable to power distribution networks that include a large number of nodes or connections. Local power controllers in accordance with the present invention can be provided as small distributed ICs, for example, with low pin counts and wide power or thermal distribution. The simplified power controller can be used to provide power control for high power systems, for example, while maintaining simplicity and reduced cost for large scale power distribution systems.

The various interfaces used for the ICs or devices in accordance with the present invention to distribute control among the various ICs or devices can be selected from a broad range of buses or interfaces. For example, the high overhead main bus interface can be a standard interface where one or more of the devices interconnected in the high speed local interface are attached to the standard main bus interface. The high speed local interface may be a custom or standardized interface to provide straight forward implementation and ease of manufacture. In addition, where the system host or main controller is interconnected into the high speed local interface, as discussed above, the high speed local interface can be standardized or custom, dependent upon the application and data exchanged between the devices or host or system controller. In general, the provision of multiple interfaces in a simple device assists in the distribution of the device among various ports or lines or channels. The computational tasks can also be distributed, along with the thermal output of the distributed devices. Each device need not have multiple interfaces, but also may be interconnected with a main controller over a custom interface.

Although the present invention has been described in relation to particular embodiments thereof, other variations and modifications and other uses will become apparent to those skilled in the art from the description. It is intended therefore, that the present invention not be limited not by the specific disclosure herein, but to be given the full scope indicated by the appended claims.

What is claimed is:

1. An architecture for a distributed control system, comprising:
a plurality of control devices, each being coupled to an output and operable to influence a characteristic of the output;
a high speed interface interconnecting the control devices for transferring information among the control devices;
one or more of the control devices being coupled to a high overhead interface for transferring information over the high overhead interface.

2. The architecture according to claim 1, wherein the output is a power output.

3. The architecture according to claim 1, wherein the control devices are power control ICs.

4. The architecture according to claim 1, wherein the high speed interface is a ring bus.

5. The architecture according to claim 1, wherein the one or more control devices are operable to address the plurality of control devices to communicate with a specific control device.

6. The architecture according to claim 2, wherein the output is are arranged in a port for an Ethernet network to source or sink power over a network connection.

7. The architecture according to claim 6, wherein the control devices are power control ICs located in close proximity to the respective ports.

8. The architecture according to claim 7, wherein each port further comprises a port housing and the IC is located within the housing.

9. The architecture according to claim 1, wherein the one or more control devices are integrated into a system controller.

10. The architecture according to claim 1, wherein each control device in the plurality includes connections for the high overhead interface and the high speed interface.

11. A method for controlling a plurality of signal connections comprising:
controlling each signal connection with an associated control device;
communicating between the control devices with a high speed interface; and
communicating with a host system through one or more of the control devices coupled to a main interface.

12. The method according to claim 11, wherein the signal connection is a power connection and the control devices are power control ICs.

13. The method according to claim 11, further comprising applying a control to the signal connections by transferring control information over the high speed interface to the control devices.

14. The method according to claim 11, further comprising addressing specific control devices through the high speed interface by the one or more control devices.

15. The method according to claim 11, further comprising addressing the one or more control devices through the main interface by the host system.

16. A system for providing control for a power over Ethernet (POE) application, comprising:
a power controller coupled to an Ethernet port for controlling power transferred through the port;
a high speed interface in the power controller for communicating power control information;
a high overhead interface in the power controller for communicating power control information; and
the power controller being operable to control power transferred through the Ethernet port based on power control information obtained through one or more of the interfaces.

17. The system according to claim 16, further comprising:
a plurality of power controllers, each being coupled to an Ethernet port to control power transferred through the port; and
the plurality of power controllers being interconnected through the high speed interface.

18. The system according to claim 17, further comprising a host system coupled to at least one of the power controllers through the high overhead interface.

19. The system according to claim 18, wherein the power controllers other than the at least one power controller have disabled high overhead interfaces.

20. The system according to claim 16, wherein the power controllers are ICs.
